(19) United States
(12) Patent Application Publication
(10) Pub. No.: US 2025/0384265 A1
(43) Pub. Date: Dec. 18, 2025

(54) COMPUTATIONAL STORAGE SYSTEM, OPERATING METHOD THEREOF, AND ELECTRONIC DEVICE

(71) Applicant: SAMSUNG ELECTRONICS CO., LTD., Suwon-si (KR)

(72) Inventor: Sooyoung JI, Suwon-si (KR)

(73) Assignee: SAMSUNG ELECTRONICS CO., LTD., Suwon-si (KR)

(21) Appl. No.: 19/027,533

(22) Filed: Jan. 17, 2025

(30) Foreign Application Priority Data
Jun. 14, 2024 (KR) 10-2024-0077757

(51) Int. Cl. G06N 3/08

(52) U.S. Cl. CPC G06N 3/08

(57) ABSTRACT

A computational storage system includes: a storage device configured to store a first neural network model, a second neural network model, and an interpreter neural network model; and a computing device configured to transform data, transmitted and received between the first neural network model and the second neural network model, into a parameter corresponding to the data by using the interpreter neural network model, based on a first training table, a second training table, and a first transformation table, and transmit and/or receive the parameter between the first neural network model and the second neural network model.

### CROSS-REFERENCE TO RELATED APPLICATION

This application is based on and claims priority under 35 U.S.C. § 119 to Korean Patent Application No. 10-2024-0077757, filed on Jun. 14, 2024, in the Korean Intellectual Property Office, the disclosure of which is herein incorporated by reference in its entirety.

### BACKGROUND

One or more example embodiments of the disclosure relate to a computational storage system for smoothly performing data (or information) communication between a plurality of neural network models, based on an interpreter neural network model.

Recently, artificial intelligence (AI)/machine learning (ML) technologies are being developed along with computational storage systems including elements of a storage device and computing devices capable of processing data. Therefore, devices equipped with on-device AI that enables an electronic device to autonomously process information or data without needing to connect to a server or a cloud are being introduced. As on-device AI-based applications or services provided by such devices increase, a plurality of neural network models based on databases (DBs) associated with various fields may be stored in a computational storage system. To provide an on-device AI-based application or service, the plurality of neural network models may transmit or receive (e.g., communicate) mutual data and may operate together. However, because each of the plurality of neural network models operates by using different data (or data representation), there is a problem where communication (e.g., transmission or reception of data or information) between the plurality of neural network models is not smooth.

### SUMMARY

One or more example embodiments of the disclosure provide a computational storage system for smoothly performing data transmission/reception (or communication) between a plurality of neural network models, based on an interpreter neural network model, an operating method of the computational storage system, and an electronic device.

The object of the disclosure is not limited to the aforesaid, but other objects not described herein will be clearly understood by those of ordinary skill in the art from descriptions below.

According to an aspect of an example embodiment of the disclosure, provided is a computational storage system including: a storage device configured to a first neural network model, a second neural network model, and an interpreter neural network model and a computing device configured to transform data, transmitted and received between the first neural network model and the second neural network model, into a parameter corresponding to the data by using the interpreter neural network model, based on a first training table, a second training table, and a first transformation table, and transmit and/or receive the parameter between the first neural network model and the second neural network model.

According to an aspect of an example embodiment of the disclosure, provided is a method of operating a computational storage system based on an interpreter neural network model including: receiving first data used in a first neural network model from the first neural network model; determining a first parameter corresponding to the first data, based on a first training table; transforming the first parameter of the first neural network model into a second parameter of the second neural network model, based on a first transformation table; and transmitting the second parameter corresponding to the second data to the second neural network model, wherein the second data corresponds to the first data of the first neural network model among pieces of data used in the second neural network model.

According to an aspect of an example embodiment of the disclosure, provided is an electronic device including: at least one memory configured to store a first neural network model, a second neural network model, and an interpreter neural network model and at least one processor, wherein, by using the interpreter neural network model, the processor is configured to map first data, used in the first neural network model, to a first parameter corresponding to the first data to generate a first training table, map second data, used in the second neural network model, to a second parameter corresponding to the second data to generate a second training table, map the first parameter of the first neural network model to the second parameter of the second neural network model to generate a first transformation table, and transform data, transmitted and received between the first neural network model and the second neural network model, into a parameter corresponding to the data, based on the first training table, the second training table, and the first transformation table, and transmit and/or receive the parameter, between the first neural network model and the second neural network model.

### BRIEF DESCRIPTION OF DRAWINGS

Example embodiments will be more clearly understood from the following detailed description taken in conjunction with the accompanying drawings in which:

FIG. 1 is a block diagram illustrating an electronic device according to one or more embodiments;

FIG. 2 is a block diagram illustrating a computational storage system according to one or more embodiments;

FIG. 3 is a block diagram illustrating neural network models of a computational storage system according to one or more embodiments;

FIG. 4 is a diagram for describing an operation of a computational storage system based on an interpreter neural network model, according to one or more embodiments;

FIG. 5 is a diagram for describing operation of a computational storage system based on an interpreter neural network model, according to one or more embodiments;

FIG. 6 is a block diagram illustrating neural network models of a computational storage system according to one or more embodiments;

FIG. 7 is a block diagram illustrating neural network models of a computational storage system according to one or more embodiments;

FIG. 8 is a block diagram illustrating neural network models of a computational storage system according to one or more embodiments;

FIG. 9 is a diagram for describing operation of a computational storage system based on an interpreter neural network model, according to one or more embodiments;

FIG. 10 is a diagram for describing operation of a computational storage system based on an interpreter neural network model, according to one or more embodiments;

FIG. 11 is a flowchart illustrating an operating method of a computational storage system, according to one or more embodiments; and

FIG. 12 is a block diagram illustrating an electronic device according to one or more embodiments.

### DETAILED DESCRIPTION

Hereinafter, example embodiments will be described in detail with reference to the accompanying drawings. Example embodiments are illustrated in the drawings, and detailed descriptions relevant thereto are described, but various embodiments are not limited to a certain form. For example, it is obvious to those of ordinary skill in the art that embodiments may be variously modified.

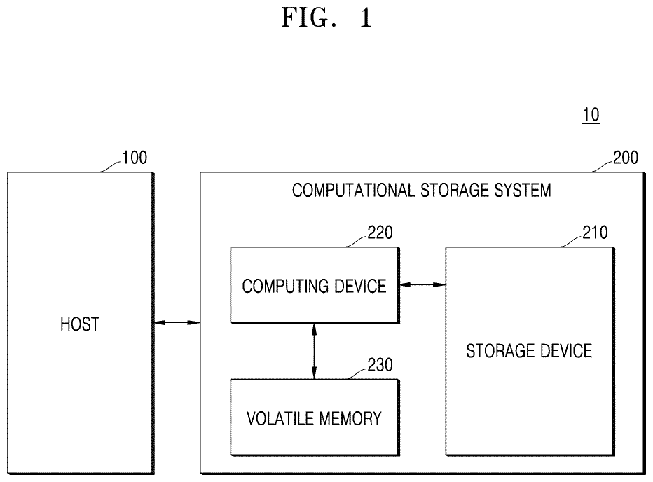

FIG. 1 is a block diagram illustrating an electronic device 10 according to one or more embodiments.

Referring to FIG. 1, the electronic device 10 according to one or more embodiments may include a host 100 and a computational storage system 200.

The electronic device 10 may be a personal computer (PC), an ultra mobile PC (UMPC), a workstation, a net-book, a network-attached storage (NAS), a smart television, an Internet of things (IoT) device, or a portable electronic device. The portable electronic device may be a laptop computer, a mobile phone, a smartphone, a tablet PC, a personal digital assistant (PDA), an enterprise digital assistant (EDA), a digital still camera, a digital video camera, an audio device, a portable multimedia player (PMP), a personal navigation device (PND), an MP3 player, a handheld game console, an e-book, or a wearable device. The computational storage system 200 may include a storage device 210, a computing device 220, and a volatile memory (VM) 230.

The host 100 may manage an overall operation of the electronic device 10. The host 100 may store data in the computational storage system 200 and may read data from the computational storage system 200. For example, the host 100 may transmit a write request and store write data in the computational storage system 200, or may transmit a read request to the computational storage system 200. Also, the host 100 may allocate a task and data to the computational storage system 200 and may control the computational storage system 200 to perform a task. For example, the host 100 may transmit, to the computational storage system 200, a data processing request for performing a task and data which is to be processed in the computational storage system 200, or may transmit, to the computational storage system 200, a data processing request for data stored in the computational storage system 200.

In an embodiment, the host 100 may transmit a training table generation request to the computational storage system 200. The training table generation request may be a request which allows the computing device 220 of the computational storage system 200 to generate a training table of each of a plurality of neural network models by using an interpreter neural network model and store the training table in the storage device 210.

In an embodiment, the host 100 may transmit a transformation table generation request to the computational storage system 200. The transformation table generation request may be a request which allows the computing device 220 of the computational storage system 200 to generate a transformation table for parameter transformation between the plurality of neural network models by using the interpreter neural network model and store the transformation table in the storage device 210.

The host 100 may be implemented as a central processing unit (CPU), a processor, a microprocessor, an application processor (AP), and/or a system-on-a-chip (SoC).

The computational storage system 200 may be referred to as a computational storage device. The computational storage system 200 may store or process data in response to a request from the host 100. In an embodiment, the computational storage system 200 may internally store or process data and may thus be implemented with a storage acceleration platform which accelerates data processing. For example, the computational storage system 200 may be a smart solid state drive (SSD).

The storage device 210 may store data provided from the host 100. In an embodiment, the storage device 210 may store the plurality of neural network models generated by the computing device 220, the training table of each of the plurality of neural network models, the transformation table between the plurality of neural network models, and/or the interpreter neural network model. Also, in an embodiment, the storage device 210 may store a parameter transformed based on the training table and the transformation table by the computing device 220 by using the interpreter neural network model.

The computing device 220 may be a device which performs data processing on received data and may perform data processing in response to a data processing request received from the host 100. For example, the computing device 220 may drive an application and may thus perform data processing on input data using the application. The application may include a plurality of data operations (for example, an arithmetic operation, a convolution operation, and/or a pooling operation) associated with task performance. For example, in a case where the computing device 220 performs a task based on a neural network, the application may include a neural network model. The neural network model may include a plurality of data operations based on, for example, at least one of convolution neural network CNN), region with convolution neural network (R-CNN), region proposal network (RPN), recurrent neural network (RNN), stacking-based deep neural network (S-DNN), state-space dynamic neural network (S-SDNN), deconvolution network, deep belief network (DBN), restricted Boltzmann machine (RBM), fully convolutional network, long short-term memory (LSTM) Network, classification network, and various kinds of neural networks and inputs, output sizes and weights, and biases of the plurality of data operations.

For example, the computing device 220 may be implemented with a graphics processing unit (GPU), a digital signal processor (DSP), a field programmable gate array (FPGA), an application specific integrated circuit (ASIC), and/or a neural processing unit (NPU). However, an embodiment is not limited thereto, and the computing device 130 may be implemented with various kinds of acceleration circuits (e.g., accelerators) which perform in parallel data processing (for example, a data operation) needed for allocated task performance.

In an embodiment, the computing device 220 may map data, used in each neural network model, to a parameter corresponding to the data by using the interpreter neural network model to generate a training table, in response to the training table generation request received from the host 100. Each neural network model and the generated training table may have a one-to-one relationship therebetween, but are not limited thereto.

In an embodiment, the computing device 220 may map a parameter of a first neural network model to a parameter of a second neural network model corresponding thereto by using the interpreter neural network model to generate a transformation table, in response to the transformation table generation request received from the host 100.

In an embodiment, in response to a data transformation request received from the host 100, the computing device 220 may transform data, transmitted and received between the first neural network model and the second neural network model, into a parameter corresponding to the data by using the interpreter neural network model, based on the training table and the transformation table, and may transmit or receive the parameter. Here, it is assumed that the first neural network model and the second neural network model use different data (or data representation). For example, in a case of transmitting first data of the first neural network model to the second neural network model, by using the interpreter neural network model, the computing device 220 may determine the first data of the first neural network model as a first parameter, based on a training table of the first neural network model, may transform the first parameter into a second parameter of the second neural network model, based on the transformation table, and may transmit the second parameter corresponding to the second data to the second neural network model. In this case, the second data may be data corresponding to the first data of the first neural network model among pieces of data used in the second neural network model.

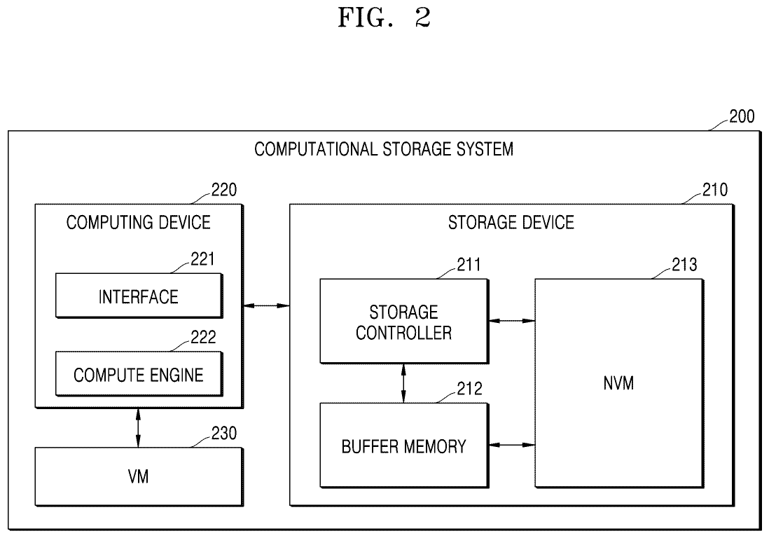

As described above, the interpreter neural network model according to one or more embodiments may transform data, transmitted and received between the first neural network model and the second neural network model, into a common parameter of the first neural network model and the second neural network model and may transmit or receive the common parameter, and thus, the first neural network model and the second neural network model may smoothly perform data transmission and/or reception (or communication). A detailed configuration and operation of the computing device 220 will be described below in more detail later with reference to FIG. 2.

The volatile memory 230 may store data used in data processing of the computing device 220. The volatile memory 230 may store data generated by the computing device 220 or data generated as a result of data processing. Here, in a case where the computing device 220 performs data processing, based on data stored in the storage device 210, the data (for example, the plurality of neural network models, the training table, the transformation table, the interpreter neural network model, etc.) stored in the storage device 210 may be read and stored in the volatile memory 230.

The volatile memory 230 may be implemented as a volatile memory such as a dynamic random access memory (RAM) (DRAM) or a static RAM (SRAM).

FIG. 2 is a block diagram illustrating a computational storage system 200 according to one or more embodiments.

Referring to FIG. 2, the computational storage system 200 according to one or more embodiments may include a storage device 210, a computing device 220, and a volatile memory (VM) 230.

The computing device 220 may include an interface 221 and a compute engine 222.

The interface 221 may manage the transmission of data and a request between the host 100 and the compute engine 222 of the computing device 220 in the computational storage system 200. Also, the interface 221 may manage the transmission of data and a request between the host 100 and the storage device 210 in the computational storage system 200.

The interface 221 may receive a data processing request (for example, a data transformation request), a training table generation request, and a transformation table generation request from the host 100. The data processing request may be a request which allows the computing device 220 to perform data processing on data stored in the storage device 210 or perform data processing on data received from the host 100. When the interface 221 receives the data processing request from the host 100, the interface 221 may transmit the data processing request to the compute engine 222. Therefore, the compute engine 222 of the computing device 220 may perform data processing corresponding to the data processing request.

In an embodiment, the interface 221 may receive the data transformation request from the host 100. In response to the data transformation request, the computing device 220 may transform data, transmitted and received between a first neural network model and a second neural network model, into a parameter corresponding to the data by using an interpreter neural network model, based on a training table and a transformation table, and may transmit or receive the parameter (the first neural network model and the second neural network model may be assumed to use different data (or data representation)).

In an embodiment, the training table generation request received through the interface 221 from the host 100 may be a request which allows the computing device 220 of the computational storage system 200 to generate a training table of each of a plurality of neural network models by using the interpreter neural network model and store the training table in the storage device 210. When the interface 221 receives the training table generation request from the host 100, the interface 221 may transmit the training table generation request to the compute engine 222. Therefore, the compute engine 222 of the computing device 220 may map data, used in each neural network model, to a parameter corresponding to the data to generate a training table corresponding to each neural network model.

In an embodiment, the host 100 may transmit the transformation table generation request to the computational storage system 200. The transformation table generation request may be a request which allows the computing device 220 of the computational storage system 200 to generate a transformation table for parameter transformation between the plurality of neural network models by using the interpreter neural network model and store the transformation table in the storage device 210. When the interface 221 receives the transformation table generation request from the host 100, the interface 221 may transmit the transformation table generation request to the compute engine 222. Therefore, the compute engine 222 of the computing device 220 may map a parameter of a neural network model to a parameter of another neural network model corresponding thereto to generate a transformation table.

In an embodiment, the interface 221 may receive a neural network model read request from the host 100. The neural network model read request may be a request which allows the computing device 220 to read a neural network model stored in the storage device 210. When the interface 221 receives the neural network model read request from the host 100, the interface 221 may transmit the neural network model read request to the storage device 210. Therefore, a neural network model (for example, an interpreter neural network model, etc.) read from a non-volatile memory 213 of the storage device 210 may be transmitted to the host 100.

The compute engine 222 may perform data processing in response to the data processing request. The compute engine 222 may perform data processing on data stored in the storage device 210 or data processing on data received from the host 100, in response to the data processing request. The compute engine 222 may store a value, calculated in a data processing operation, in a register thereof. Also, the compute engine 222 may store, in the volatile memory 230, data generated in a data processing operation and data generated as a result of data processing. The compute engine 222 may store the data, generated as the result of data processing, in the storage device 210 through the interface 221.

In an embodiment, the compute engine 222 may map data, used in each neural network model, to a parameter corresponding to the data to generate a training table corresponding to each neural network model. For example, the computing device 220 may continuously perform communication (for example, FAQ) with each neural network model by using the interpreter neural network model to maintain synchronization (Sync).

In an embodiment, the compute engine 222 may map a parameter of a neural network model to a parameter of another neural network model corresponding thereto to generate a transformation table.

In an embodiment, the compute engine 222 may map a transformation table and a training table corresponding to each neural network model by using the interpreter neural network model.

In an embodiment, the compute engine 222 may transform data, transmitted and received between a first neural network model and a second neural network model, into a parameter corresponding to the data by using the interpreter neural network model, based on the training table and the transformation table, and may transmit or receive the parameter (the first neural network model and the second neural network model may be assumed to use different data (or data representation)). The compute engine 222 may store a parameter, obtained through a transformation based on the transformation table, in the volatile memory 230 (or the storage device 210).

In an embodiment, the first neural network model may be a neural network model which performs a natural language processing function of a user, based on a user related database (DB), and the second neural network model may be a neural network model which performs a data inference function except the natural language processing function of the user, based on a predetermined target field related DB.

In an embodiment, the first neural network model may be a neural network model which is trained based on first training data in at least one embedded field programmable gate array (eFPGA) circuit of the computing device 220, and the second neural network model may be a neural network model which is trained based on second training data differing from the first training data in at least one FPGA circuit of the computing device 220.

In an embodiment, the first neural network model may be a neural network model which is trained based on a DB related to a first field (for example, lecture field), and the second neural network model may be a neural network model which is trained based on a DB related to a second field (for example, economy field) which differs from the first field.

In an embodiment, the compute engine 222 may select, based on data received from the first neural network model, a neural network model corresponding to the received data among a plurality of neural network models by using the interpreter neural network model, may determine a parameter corresponding to the received data, based on a training table of the first neural network model, may transform the parameter into a parameter of the selected neural network model, based on the transformation table, and may transmit the transformed parameter to the selected neural network model.

A raw image data storage request or a storage request for a neural network model, an event table, and basic data each generated by the compute engine 222 may be transmitted to the storage device 210 through the interface 221.

The storage device 210 may include a storage controller 211, a buffer memory 212, and the non-volatile memory (NVM) 213.

The storage controller 211 may manage an overall operation of the storage device 210 and may control the non-volatile memory 213 such that an operation based on a request received from the host 100 is performed. For example, in response to a write or read request from the host 100, the storage controller 211 may control the non-volatile memory 213 such that data is written in the non-volatile memory 213 or is read from the non-volatile memory 213 and may control an erase operation of the non-volatile memory 213. Also, the storage controller 211 may manage main operations of the non-volatile memory 213 such as garbage collection, bad block management, read reclaim, and read replacement and may manage power of the non-volatile memory 213.

The buffer memory 212 may operate as a buffer which temporarily stores data, in the storage device 210. The buffer memory 212 may store data which is received from the host 100 or is read from the non-volatile memory 213. Also, the buffer memory 212 may store data generated by the computing device 220.

The buffer memory 212 may be implemented as a volatile memory such as a DRAM or an SRAM. However, the disclosure is not limited thereto, and the buffer memory 212 may be implemented as various kinds of non-volatile memories such as, for example, a flash memory, a nano floating gate memory (NFGM), a polymer RAM (PoRAM), a ferroelectric RAM (FRAM), or a resistive non-volatile memory such as a magnetic RAM (MRAM), a phase change RAM (PRAM), or a resistive RAM (ReRAM). In an embodiment, the buffer memory 212 is illustrated as being provided outside the storage controller 211, but is not limited thereto and may be included in the storage controller 211.

The non-volatile memory 213 may store data. The non-volatile memory 213 may store data provided from the host 100 and/or data provided from the computing device 220. The non-volatile memory 213 may include a memory cell array including non-volatile memory cells which may retain data even when power of the storage device 210 is cut off, and the memory cell array may be divided into a plurality of memory blocks. The plurality of memory blocks may have a two-dimensional (2D) horizontal structure where memory cells are two-dimensionally arranged on the same plane (or layer), or may have a three-dimensional (3D) vertical structure where non-volatile memory cells are three-dimensionally arranged. Each of the memory cells may be a single level cell (SLC) which stores data of 1 bit, or may be a multi level cell (MLC) which stores data of 2 or more bits. However, the disclosure is not limited thereto, and each memory cell may be a triple level cell (TLC) which stores data of 3 bits, or may be a quadruple level cell which stores data of 4 bits.

In some embodiments, the non-volatile memory 213 may include a plurality of chips or a plurality of dies each including a memory cell array (MCA). For example, the non-volatile memory 213 may include a plurality of chips, and each of the plurality of chips may include a plurality of dies. In an embodiment, the non-volatile memory 213 may include a plurality of channels each including a plurality of chips.

In an embodiment, the non-volatile memory 213 may be a NAND flash memory device. However, the disclosure is not limited thereto, and the non-volatile memory 213 may be implemented as a resistive memory device such as an ReRAM, a PRAM, or an MRAM.

In an embodiment, the storage controller 211 may receive a storage request for a training table, a transformation table, an interpreter neural network model, and a plurality of neural network models using an access protocol, the training table, the transformation table, the interpreter neural network model, and the plurality of neural network models through the interface 221 of the computing device 220. The storage controller 211 may store the training table, the transformation table, the interpreter neural network model, and the plurality of neural network models in the non-volatile memory 213 in response to the storage request, received from the computing device 220, for the training table, the transformation table, the interpreter neural network model, and the plurality of neural network models using the access protocol.

In an embodiment, the storage controller 211 may receive a storage request for a transformed parameter using the access protocol and the transformed parameter through the interface 221 of the computing device 220. The storage controller 211 may store the transformed parameter in the non-volatile memory 213 in response to the storage request, received from the computing device 220, for the transformed parameter using the access protocol.

In an embodiment, the storage controller 211 may receive a neural network model (for example, target field related neural network model, user related neural network model, or interpreter neural network model) read request transmitted from the host 100 through the interface 221 of the computing device 220. For example, the storage controller 211 may read a neural network model which is a target of the neural network model read request, in response to the neural network model read request.

In an embodiment, the storage controller 211 may receive the training table and/or transformation table read request (or a transformed parameter read request), transmitted from the host 100, through the interface 221 of the computing device 220. For example, the storage controller 211 may read the training table and/or the transformation table which is a target of the training table and/or transformation table read request, in response to the training table and/or transformation table read request. For example, the storage controller 211 may read the transformed parameter which is a target of the transformed parameter read request, in response to the transformed parameter read request.

As described above, as the computational storage system 200 according to one or more embodiments is used, the computing device 220 may transform data, transmitted and received between a plurality of neural network models, into a parameter corresponding to common data of the plurality of neural network models by using the interpreter neural network model, based on the training table and the transformation table, and may transmit or receive the parameter, and thus, data transmission/reception (or communication) between the plurality of neural network models may be smoothly performed.

Accordingly, the computational storage system 200 according to one or more embodiments may smoothly perform communication between a plurality of neural network models using different data (or data representation) by using the interpreter neural network model.

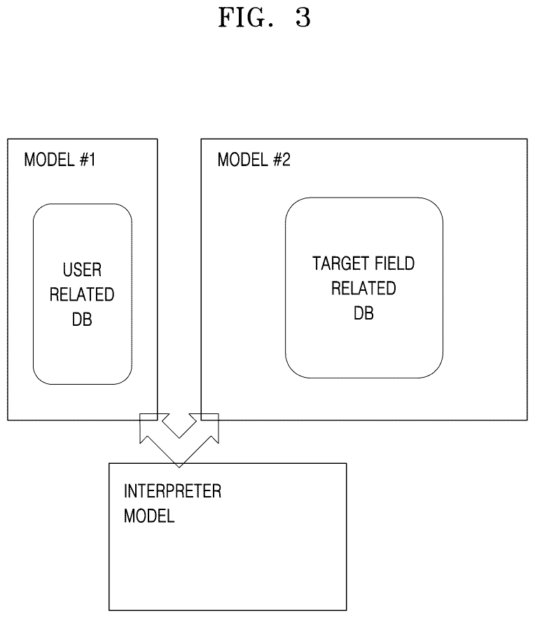

FIG. 3 is a block diagram illustrating neural network models of the computational storage system 200 according to one or more embodiments.

Referring to FIG. 3, the computational storage system 200 according to one or more embodiments (or the electronic device 10 including the same) may divide a neural network model (for example, a first neural network model Model #1) for natural language processing of a user and another neural network model (for example, a second neural network model Model #2) for performing a data inference function to store as different neural network models. Here, the first neural network model Model #1 may be a neural network model which performs a natural language processing function of the user, based on a user related DB. For example, the first neural network model Model #1 may be trained in a user customized fashion based on an individual personality and an expression of the user. The second neural network model Model #2 may be a neural network model which performs the data inference function except the natural language processing function of the user, based on a DB related to a predetermined target field. For example the second neural network model Model #2 may be trained based on massive information or knowledge related to the predetermined target field (for example, law, lecture, investment, etc.). The computational storage system 200 according to one or more embodiments may divide the neural network model which performs the natural language processing function of the user and the neural network model which performs the data inference function and may manage neural network models which perform a plurality of data inference functions based on one neural network model which performs the natural language processing function of the user, by using the interpreter neural network model. Accordingly, overlapping of trainings on separate natural language processing of a user for each neural network model performing a data inference function may be prevented.

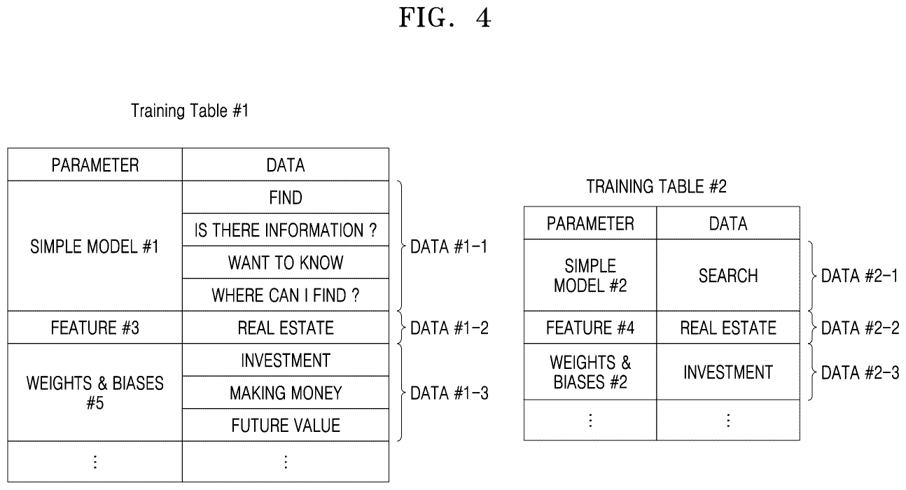

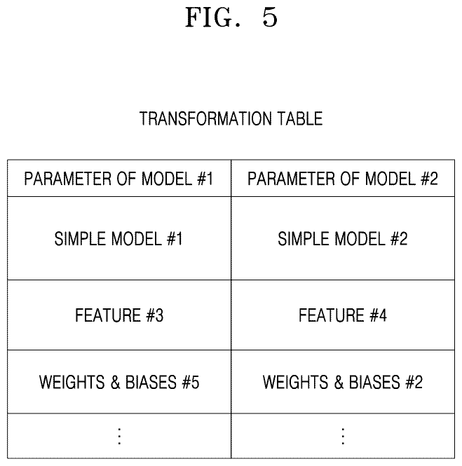

The first neural network model Model #1 and the second neural network model Model #2 may need mutual data transmission/reception (e.g., communication between neural network models), to provide an on-device AI-based service described above. In this case, the first neural network model Model #1 and the second neural network model Model #2 may use different data in a training table for each neural network model, which will be described with reference to FIG. 5. Therefore, the computing device 220 may transform data, transmitted and received between neural network models, into a parameter by using the interpreter neural network model and may transmit or receive the parameter, for smooth data exchange and communication between the neural network models (for example, the first neural network model Model #1 and the second neural network model Model #2). In this case, the parameter may denote common data which is used in common in the neural network models (for example, the first neural network model Model #1 and the second neural network model Model #2). An interpreter neural network model-based transformation operation of the computing device 220 will be described below with reference to FIGS. 4 and 5. FIG. 4 is a diagram for describing an operation of a computational storage system based on an interpreter neural network model, according to one or more embodiments. FIG. 5 is a diagram for describing an operation of a computational storage system based on an interpreter neural network model, according to one or more embodiments.

Referring to FIGS. 3 to 5, the computing device 220 may receive at least one piece of data Data #1-1 (for example, ‘find’) from the first neural network model Model #1. The computing device 220 may determine a first simple model Simple Model #1 as a parameter corresponding to the at least one piece of data Data #1-1 (for example, ‘find’), by using the interpreter neural network model based on a first training table Training Table #1 of FIG. 4. The computing device 220 may transform the parameter (for example, the first simple model (Simple Model #1)) of the first neural network model Model #1 into a parameter (for example, a second simple model Simple Model #2) of the second neural network model Model #2 corresponding thereto by using the interpreter neural network model, based on a transformation table of FIG. 5. The computing device 220 may transmit a transformed parameter (for example, the second simple model Simple Model #2) to the second neural network model Model #2 by using the interpreter neural network model. The second neural network model Model #2 may interpret data, transmitted from the first neural network model Model #1, as data Data #2-1 (for example, ‘Search’) corresponding to the transformed parameter (for example, the second simple model Simple Model #2) in response to receiving the transformed parameter (for example, the second simple model Simple Model #2).

Accordingly, the computational storage system 200 according to one or more embodiments may transform data, transmitted and received between a plurality of neural network models, into a parameter corresponding to common data of the plurality of neural network models by using the interpreter neural network model, and thus, data transmission/reception (or communication) between the plurality of neural network models may be smoothly performed.

Referring back to FIG. 4, FIG. 4 is a diagram for describing an operation of generating a training table for each neural network model by using the computing device 220 of the computational storage system 200, based on an interpreter neural network model. In FIG. 4, the first neural network model Model #1 may be a neural network model for natural language processing of a user in FIG. 3, and the second neural network model Model #2 may be an integration neural network model which is trained based on a target field related DB of FIG. 3.

Referring to FIG. 4, by using the interpreter neural network model, the computing device 220 may generate a first training table (Training Table #1) for the first neural network model Model #1 and may generate a second training table (Training Table #2) for the second neural network model Model #2. A training table may denote a table which is generated by mapping data, used in each neural network model, to a parameter corresponding to the data. Here, the parameter may include a simple model, a feature, weights and biases, and a specific pattern representation value. The simple model may be a parameter representing ‘function and/or equation’ related data trained based on a related DB by using a corresponding neural network model, the feature may be a parameter representing training item related data trained based on a related DB by using a corresponding neural network model, and the weights and biases may be parameters representing ‘a weight and a ratio value of training item’ related data trained based on a related DB by using a corresponding neural network model.

In an embodiment, by using the interpreter neural network model, the computing device 220 may map at least one piece of data Data #1-1 (for example, ‘find’, ‘is there information?’, ‘want to know’, ‘Where can I find?’) to a first simple model (Simple Model #1)), map data Data #1-2 (for example, ‘Real Estate’) to a third feature Feature #3, and map at least one piece of data Data #1-3 (for example, ‘investment’, ‘making money’, ‘future value’) to fifth weights and biases Weights&Biases #5. The computing device 220 may generate the first training table for the first neural network model Model #1 by using the interpreter neural network model, based on data-parameter mapping described above.

In an embodiment, by using the interpreter neural network model, the computing device 220 may map data Data #2-1 (for example, ‘Search’) to a second simple model Simple Model #2, map data Data #2-2 (for example, ‘Real Estate’) to a fourth feature Feature #4, and map data Data #2-3 (for example, ‘Investment’) to second weights and biases Weights&Biases #2. The computing device 220 may generate the second training table for the second neural network model Model #2 by using the interpreter neural network model, based on data-parameter mapping described above.

Referring back to FIG. 5, FIG. 5 is a diagram for describing an operation of generating a transformation table for transforming a parameter between neural network models by using the computing device 220 of the computational storage system 200, based on an interpreter neural network model. In FIG. 5, the first neural network model Model #1 may be a neural network model for natural language processing of a user in FIG. 3, and the second neural network model Model #2 may be an integration neural network model which is trained based on a target field related DB of FIG. 3.

Referring to FIG. 5, the computing device 220 may generate a transformation table between neural network models by using the interpreter neural network model. The transformation table may denote a table which is generated by mapping a parameter of a neural network model to a parameter of another neural network model corresponding thereto.

In an embodiment, by using the interpreter neural network model, the computing device 220 may map a first simple model Simple Model #1, which is a parameter of the first neural network model Model #1, to a second simple model Simple Model #2 which is a parameter of the second neural network model Model #2, map a third feature Feature #3, which is a parameter of the first neural network model Model #1, to a fourth feature Feature #4 which is a parameter of the second neural network model Model #2, and map fifth weights and biases Weights&Biases #5, which are parameters of the first neural network model Model #1, to second weights and biases Weights&Biases #2, which are parameters of the second neural network model Model #2. The computing device 220 may generate the transformation table by using the interpreter neural network model, based on above-described mapping between a parameter of a neural network model (for example, the first neural network model Model #1) and a parameter of another neural network model (for example, the second neural network model Model #2) corresponding thereto.

Accordingly, the computational storage system 200 according to one or more embodiments may transform data, transmitted and received between a plurality of neural network models, into a parameter corresponding to common data of the plurality of neural network models, based on the training table and the transformation table of FIGS. 4 and 5, and thus, data transmission/reception (or communication) between the plurality of neural network models may be smoothly performed.

Furthermore, as data transmission/reception (or communication) between a plurality of neural network models in the computational storage system 200 is smoothly performed, a reduction in performance caused by a delay of data transmission/reception (or communication) between the plurality of neural network models may be prevented.

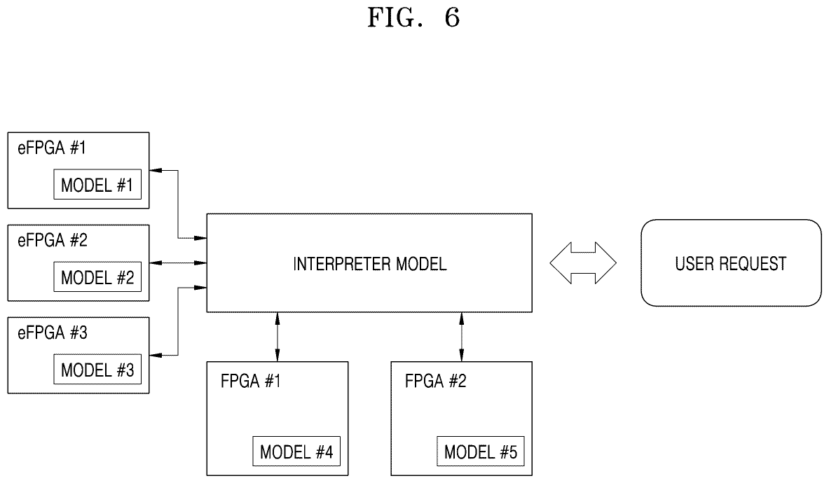

FIG. 6 is a block diagram illustrating neural network models of a computational storage system according to one or more embodiments.

Referring to FIG. 6, the computing device 220 of the computational storage system 200 according to one or more embodiments may be implemented with a plurality of eFPGAs and a plurality of FPGAs.

In an embodiment, each of the plurality of eFPGAs or each of the plurality of FPGAs may include a neural network model. For example, a first eFPGA eFPGA #1 may include a first neural network model Model #1, a second eFPGA eFPGA #2 may include a second neural network model Model #2, a third eFPGA eFPGA #3 may include a third neural network model Model #3, a first FPGA FPGA #1 may include a fourth neural network model Model #4, and a second FPGA FPGA #2 may include a fifth neural network model Model #5. In this case, each of the first to fifth neural network models Model #1 to Model #5 may be a neural network model which is trained based on different training data. For example, the first neural network model Model #1 may be a neural network model which is trained based on first training data in the first eFPGA eFPGA #1, and the fourth neural network model Model #4 may be a neural network model which is trained based on second training data in the first FPGA FPGA #1.

In an embodiment, a neural network model included in each of the plurality of eFPGAs or each of the plurality of FPGAs may be a partial neural network model which is generated by dividing one integration neural network model, based on functions. For example, each of the first neural network model Model #1, the second neural network model Model #2, and the third neural network model Model #3 may be a partial neural network model which is generated by dividing an integration neural network model for natural language processing of the user. For example, each of the fourth neural network model Model #4 and the fifth neural network model Model #5 may be a partial neural network model which is generated by dividing an integration neural network model for data inference, based on a target field (for example, law, lecture, or investment) related DB.

In an embodiment, based on a user request, the computing device 220 may transform data, transmitted and received between a plurality of neural network models (for example, the first to fifth neural network models Model #1 to Model #5), into a parameter by using an interpreter neural network model and may transmit or receive the parameter. Here, the parameter may denote data (for example, a simple model, a feature, or weights and biases) which is used by the plurality of neural network models in common. For example, the computing device 220 may generate a training table (see e.g., FIG. 4) for each of the first to fifth neural network models Model #1 to Model #5 by using the interpreter neural network model. For example, the computing device 220 may generate a transformation table (see e.g., FIG. 5) for parameter transformation between the first to fifth neural network models Model #1 to Model #5 by using the interpreter neural network model. By using the interpreter neural network model, the computing device 220 may determine a first parameter corresponding to first data, based on a training table corresponding to the first neural network model Model #1, select a neural network model corresponding to the first data among the plurality of neural network models (for example, the first to fifth neural network models Model #1 to Model #5), based on the first data, transform a first parameter of the first neural network model Model #1 into a parameter of the selected neural network model (for example, the fifth neural network model Model #5), based on a transformation table between the first neural network model Model #1 and the selected neural network model (for example, the fifth neural network model Model #5), and transmit and/or receive a transformed parameter to the selected neural network model (for example, the fifth neural network model Model #5).

As described above, the computational storage system 200 according to one or more embodiments may smoothly perform data transmission/reception between a plurality of neural network models trained based on different training data in different kinds of circuits (or devices) (for example, eFPGA and/or FPGA) by using the interpreter neural network model.

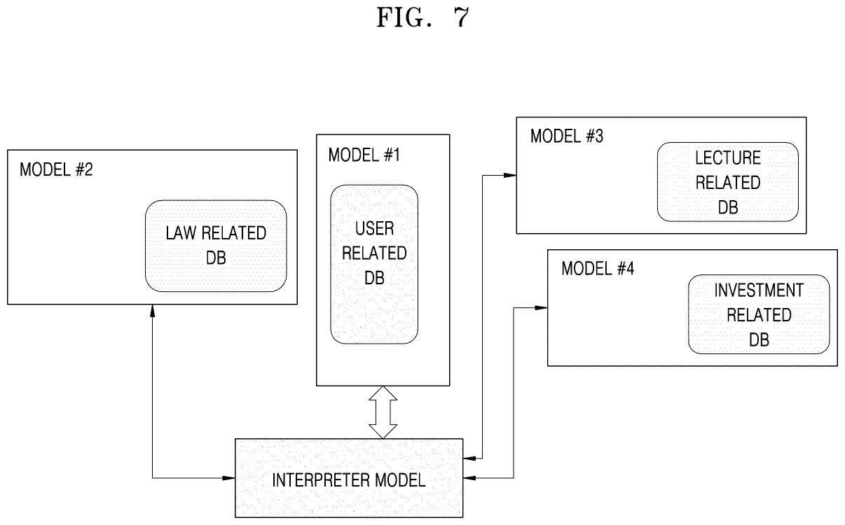

FIG. 7 is a block diagram illustrating neural network models of a computational storage system according to one or more embodiments.

Referring to FIG. 7, the computational storage system 200 according to one or more embodiments may associate a plurality of neural network models (for example, first to fourth neural network models Model #1 to Model #4) with one another by using an interpreter neural network model to provide an on-device AI-based service. In this case, each of the plurality of neural network models may be a dedicated neural network model, based on DBs of different fields. For example, the first neural network model Model #1 may be a neural network model (for example, a neural network model for natural language processing of the user) trained based on a user related DB, the second neural network model Model #2 may be a neural network model trained based on a law related DB, the third neural network model Model #3 may be a neural network model trained based on a lecture related DB, and the fourth neural network model Model #4 may be a neural network model trained based on an investment related DB.

In an embodiment, the computing device 220 may transform data, transmitted and received between a different plurality of neural network models (for example, the first to fourth neural network models Model #1 to Model #4), into a parameter by using the interpreter neural network model and may transmit or receive the parameter. That is, the computing device 220 may transform data, transmitted from a neural network model, into a parameter used in a corresponding neural network model by using the interpreter neural network model and may transmit the parameter to the corresponding neural network model, for smooth communication between a plurality of neural network models. Here, the parameter may denote data (for example, a simple model, a feature, or weights and biases) which is used by the plurality of neural network models in common. For example, the computing device 220 may generate a training table (see e.g., FIG. 4) for each of the first to fourth neural network models Model #1 to Model #4 by using the interpreter neural network model. For example, the computing device 220 may generate a transformation table (see e.g., FIG. 5) for parameter transformation between the first to fourth neural network models Model #1 to Model #4 by using the interpreter neural network model. By using the interpreter neural network model, the computing device 220 may determine a first parameter corresponding to first data, based on a training table corresponding to the first neural network model Model #1, select a neural network model corresponding to the first data among the plurality of neural network models (for example, the first to fourth neural network models Model #1 to Model #4), based on the first data, transform a first parameter of the first neural network model Model #1 into a parameter of the selected neural network model (for example, the second neural network model Model #2), based on a transformation table between the first neural network model Model #1 and the selected neural network model (for example, the second neural network model Model #2), and transmit and/or receive a transformed parameter to the selected neural network model (for example, the second neural network model Model #2).

In an embodiment, when data (or data representation) used in each of the plurality of neural network models is newly generated, changed, and/or deleted, the computing device 220 may update the training table and the transformation table to update the interpreter neural network model. For example, when a new vogue word in the natural language of the user is added to a user related DB, the computing device 220 may map the vogue word to a parameter corresponding to the vogue word to add to the training table for the first neural network model Model #1 (for example, the neural network model for natural language processing of the user) by using the interpreter neural network model and may map a parameter corresponding to the vogue word to a parameter of another neural network model corresponding thereto to add a mapped parameter in the training table corresponding to the first neural network model Model #1.

In an embodiment, when a new neural network model is added to the plurality of neural network models, the computing device 220 may smoothly perform data transmission/reception between the existing plurality of neural network models and an added neural network model by using the interpreter neural network model. For example, by using the interpreter neural network model, the computing device 220 may map data, used in the new neural network model, to a parameter corresponding to the data to generate a new training table, map parameters between the existing plurality of neural network models and new neural network models to generate a new transformation table, and transform data transmitted and received between the existing plurality of neural network models and the new neural network models into a parameter which is common data, based on the generated training table and transformation table, and thus, may smoothly perform data transmission/reception between the existing plurality of neural network models and the new neural network models.

As described above, the computational storage system 200 according to one or more embodiments may smoothly perform data transmission/reception between various kinds of a plurality of neural network models trained based on different fields related DB by using the interpreter neural network model.

Also, when a change (for example, a vogue word may be generated) occurs in data used in each neural network model, the computational storage system 200 according to one or more embodiments may adaptively reflect the vogue word in the interpreter neural network model and may train the reflected vogue word.

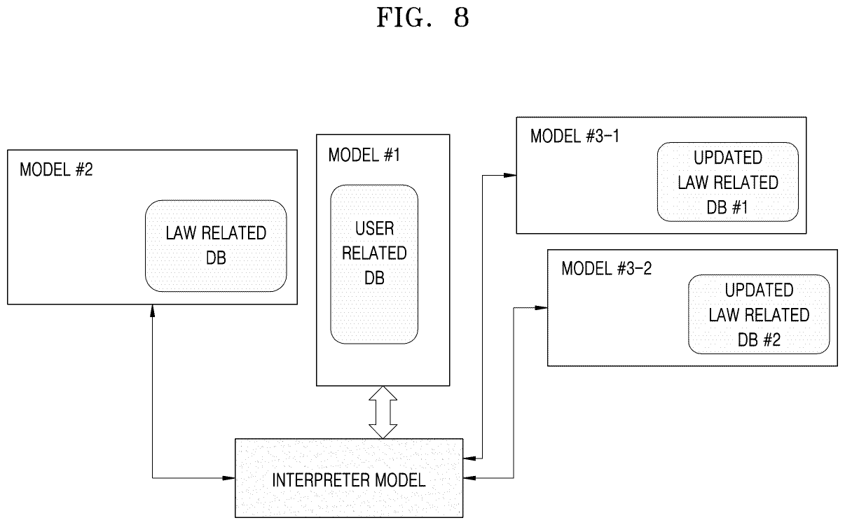

FIG. 8 is a block diagram illustrating neural network models of a computational storage system according to one or more embodiments.

Referring to FIG. 8, the computational storage system 200 according to one or more embodiments may associate a plurality of neural network models (for example, first to (3-2)th neural network models Model #1 to Model #3-2) with one another by using an interpreter neural network model to provide an on-device AI-based service. In this case, at least one neural network model (for example, the second neural network model Model #2) of the plurality of neural network models may be an integration neural network model trained based on a target field related DB, and another at least one neural network model (for example, the (3-1)th neural network model Model #3-1 and the (3-2)th neural network model Model #3-2) may be a partial neural network model trained based on an updated partial DB of the target field related DB. For example, the first neural network model Model #1 may be a neural network model (for example, a neural network model for natural language processing of the user) trained based on a user related DB, the second neural network model Model #2 may be an integration neural network model trained based on a law related DB, the (3-1)th neural network model Model #3-1 may be a neural network model trained based on an updated partial DB of a law related DB, and the (3-2)th neural network model Model #3-2 may be a neural network model trained based on another updated partial DB of a law related DB.

Generally, in a case where an integration neural network model is updated based on an updated partial DB, much time may be consumed, and a user may not be able to use the integration neural network model during an update period of the integration neural network model.

Therefore, the computing device 220 of the computational storage system 200 according to one or more embodiments may additionally generate partial neural network models (for example, the (3-1)th neural network model Model #3-1 and the (3-2)th neural network model Model #3-2) trained based on an updated partial DB and may provide the user with an on-device AI service based on the updated partial DB by using the partial neural network models (for example, the (3-1)th neural network model Model #3-1 and the (3-2)th neural network model Model #3-2) during the update period of the integration neural network model. The computing device 220 according to one or more embodiments may associate, with one another, the plurality of neural network models (for example, the first to (3-2)th neural network models Model #1 to Model #3-2) including newly added partial neural network models (for example, the (3-1)th neural network model Model #3-1 and the (3-2)th neural network model Model #3-2) by using an interpreter neural network model and may thus perform smooth communication.

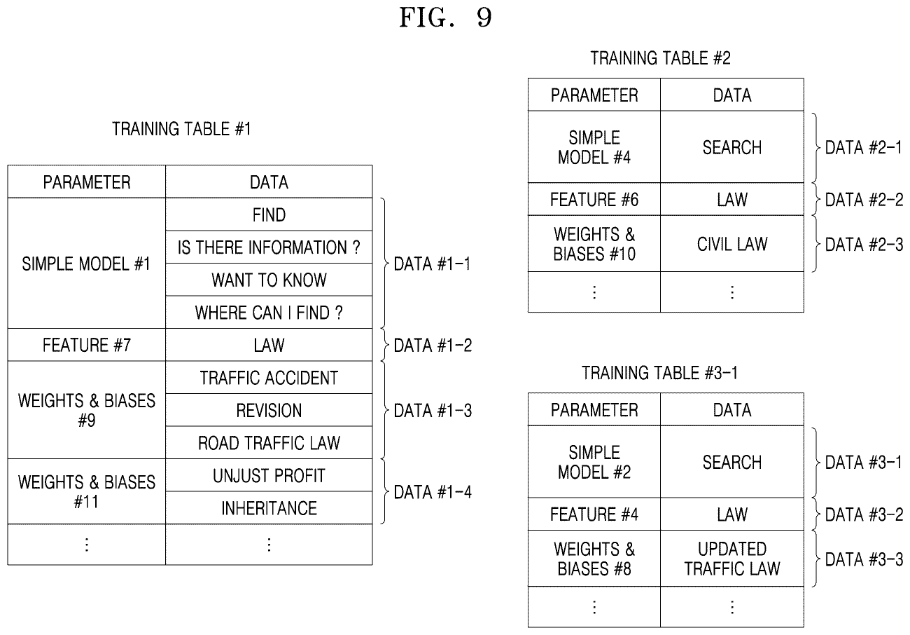

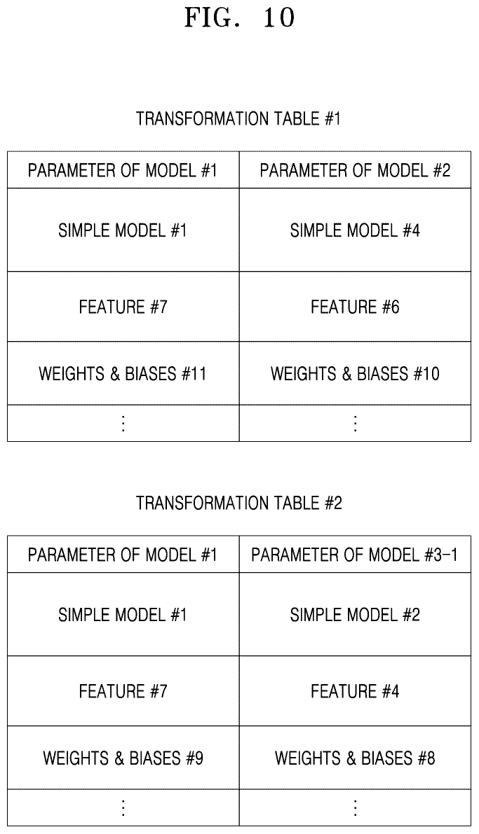

FIG. 9 is a diagram for describing operation of a computational storage system (e.g., 200 in FIG. 1) based on an interpreter neural network model, according to one or more embodiments. In an embodiment, the computing device 220 may need data transmission/reception between the plurality of neural network models (for example, the first to (3-2)th neural network models Model #1 to Model #3-2), to provide an on-device AI-based service through the updated partial DB. In this case, the plurality of neural network models (for example, the first to (3-2)th neural network models Model #1 to Model #3-2) may use different data as shown in a training table for each neural network model in FIG. 9. Therefore, the computing device 220 of the computational storage system 200 may transform data, transmitted and received between neural network models, into a parameter by using the interpreter neural network model and may transmit or receive the parameter, to enable smooth data (or information) exchange and communication between the neural network models (for example, the first to (3-2)th neural network models Model #1 to Model #3-2). In this case, the parameter may denote common data which is used in common in a plurality of neural network models (for example, first to (3-2)th neural network models Model #1 to Model #3-2). An interpreter neural network model-based transformation operation of the computing device 220 will be further described below with reference to FIGS. 9 and 10. FIG. 10 is a diagram for describing an operation of a computational storage system based on an interpreter neural network model, according to one or more embodiments.

Referring to FIGS. 8 to 10, the computing device 220 may receive at least one piece of data Data #1-3 (for example, ‘road traffic law’) from the first neural network model Model #1. In this case, it may be assumed that at least one piece of data Data #1-2 is data associated with a target field (for example, law) related DB and is used by a second neural network model Model #2, and at least one piece of data Data #1-3 is data associated with an updated partial DB of the target field (for example, law) related DB and is used by a (3-1)th neural network model Model #3-1. The computing device 220 may determine the (3-1)th neural network model Model #3-1 as a neural network model corresponding to at least one piece of data Data #1-3 (for example, ‘road traffic law’), by using the interpreter neural network model based on a plurality of training tables of FIG. 9. The computing device 220 may determine ninth weights and biases Weights&Biases #9 as parameters corresponding to the at least one piece of data Data #1-3 (for example, ‘road traffic law’), by using the interpreter neural network model based on a first training table Training Table #1 of FIG. 9. The computing device 220 may transform a parameter (for example, the ninth weights and biases Weights&Biases #9) of the first neural network model Model #1 into a parameter (for example, eighth weights and biases Weights&Biases #8) of the (3-1)th neural network model Model #3-1 corresponding thereto by using the interpreter neural network model, based on a second transformation table Transformation Table #2 of FIG. 10, which is a transformation table between the first neural network model Model #1 and a selected (3-1)th neural network model Model #3-1. The computing device 220 may transmit a transformed parameter (for example, the eighth weights and biases Weights&Biases #8) to the (3-1)th neural network model Model #3-1 by using the interpreter neural network model. The (3-1)th neural network model Model #3-1 may interpret data, transmitted from the first neural network model Model #1, as data Data #3-3 (for example, ‘Updated Traffic law’) corresponding to a transformed parameter (for example, the eighth weights and biases Weights&Biases #8) in response to receiving the transformed parameter (for example, the eighth weights and biases Weights&Biases #8).

Therefore, the computational storage system 200 according to one or more embodiments may transform data, transmitted and received between an integration neural network model (e.g., trained based on a target field related DB) and a partial neural network model (e.g., trained based on an updated partial DB of the target field related DB), into a parameter which is common data between the integration neural network model and the partial neural network model and may transmit or receive the parameter, based on the training table and the transformation table, and thus, may smoothly perform data transmission/reception (or communication) between the integration neural network model and the partial neural network model.

Referring back to FIG. 9, FIG. 9 is a diagram for describing an operation of generating a training table for each neural network model of FIG. 8 by using the computing device 220 of the computational storage system 200, based on an interpreter neural network model. In FIG. 9, a first neural network model Model #1 may be a neural network model for natural language processing of the user of FIG. 8, a second neural network model Model #2 may be an integration neural network model (for example, an integration neural network model related to laws) trained based on the target field related DB of FIG. 8, and a (3-1)th neural network model Model #3-1 may be a partial neural network model (for example, a partial neural network model related to partially revised law among laws) trained based on an updated partial DB of the target field related DB of FIG. 8.

Referring to FIG. 9, by using an interpreter neural network model, the computing device 220 may generate a first training table Training Table #1 for the first neural network model Model #1, generate a second training table Training Table #2 for the second neural network model Model #2, generate a (3-1)th training table Training Table #3-1 for the (3-1)th neural network model Model #3-1, and generate a (3-2)th training table Training Table #3-2 for the (3-2)th neural network model Model #3-2. A training table may denote a table which is generated by mapping data, used in each neural network model, to a parameter corresponding to the data. Here, the parameter may include a simple model, a feature, weights and biases, and a specific pattern representation value. The simple model may be a parameter representing ‘function and/or equation’ related data trained based on a related DB by using a corresponding neural network model, the feature may be a parameter representing training item related data trained based on a related DB by using a corresponding neural network model, and the weights and biases may be a parameter representing ‘weight and ratio value of training item’ related data trained based on a related DB by using a corresponding neural network model.

In an embodiment, by using the interpreter neural network model, the computing device 220 may map at least one piece of data Data #1-1 (for example, ‘find’, ‘is there information?’, ‘want to know’, ‘Where can I find?’) to a first simple model (Simple Model #1)), map data Data #1-2 (for example, ‘law’) to a seventh feature Feature #7, map at least one piece of data Data #1-3 (for example, ‘traffic accident’, ‘revision’, and ‘road traffic law’) to ninth weights and biases Weights&Biases #9, and map data Data #1-4 (for example, ‘unjust profit’, and ‘inheritance’) to eleventh weights and biases Weights&Biases #11. The computing device 220 may generate the first training table Training Table #1 for the first neural network model Model #1 by using the interpreter neural network model, based on data-parameter mapping described above.

In an embodiment, by using the interpreter neural network model, the computing device 220 may map data Data #2-1 (for example, ‘Search’) to a fourth simple model Simple Model #4, map data Data #2-2 (for example, ‘Law’) to a sixth feature Feature #6, and map data Data #2-3 (for example, ‘Civil law’) to tenth weights and biases Weights&Biases #10. The computing device 220 may generate the second training table Training Table #2 for the second neural network model Model #2 by using the interpreter neural network model, based on data-parameter mapping described above.

In an embodiment, by using the interpreter neural network model, the computing device 220 may map data Data #3-1 (for example, ‘Search’) to a second simple model Simple Model #2, map data Data #3-2 (for example, ‘Law’) to a fourth feature Feature #4, and map data Data #3-3 (for example, ‘Updated Traffic law’) to eighth weights and biases Weights&Biases #8. The computing device 220 may generate the (3-1)th training table Training Table #3-1 for the (3-1)th neural network model Model #3-1 by using the interpreter neural network model, based on data-parameter mapping described above.

Referring to back to FIG. 10, FIG. 10 is a diagram for describing an operation of generating a transformation table for transforming a parameter between the neural network models of FIG. 8 by using the computing device 220 of the computational storage system 200, based on an interpreter neural network model. In FIG. 10, a first neural network model Model #1 may be a neural network model for natural language processing of the user of FIG. 8, a second neural network model Model #2 may be an integration neural network model (for example, an integration neural network model related to laws) trained based on the target field related DB of FIG. 8, and a (3-1)th neural network model Model #3-1 may be a partial neural network model (for example, a partial neural network model related to partially revised law among laws) trained based on an updated partial DB of the target field related DB of FIG. 8.

Referring to FIG. 10, the computing device 220 may generate a transformation table between neural network models by using the interpreter neural network model. The transformation table may denote a table which is generated by mapping a parameter of a neural network model to a parameter of another neural network model corresponding thereto.

In an embodiment, by using the interpreter neural network model, the computing device 220 may map a first simple model Simple Model #1, which is a parameter of the first neural network model Model #1, to a fourth simple model Simple Model #4, which is a parameter of the second neural network model Model #2, map a seventh feature Feature #7, which is a parameter of the first neural network model Model #1, to a sixth feature Feature #6 which is a parameter of the second neural network model Model #2, and map eleventh weights and biases Weights&Biases #11, which are parameters of the first neural network model Model #1, to tenth weights and biases Weights&Biases #10 which are parameters of the second neural network model Model #2. The computing device 220 may generate a first transformation table Transformation Table #1 by using the interpreter neural network model, based on above-described mapping between a parameter of a neural network model (for example, the first neural network model Model #1) for natural language processing of the user and a parameter of an integration neural network model (for example, the second neural network model Model #2) corresponding thereto.

In an embodiment, by using the interpreter neural network model, the computing device 220 may map a first simple model Simple Model #1, which is a parameter of the first neural network model Model #1, to a second simple model Simple Model 2, which is a parameter of the (3-1)th neural network model Model #3-1, map a seventh feature Feature #7, which is a parameter of the first neural network model Model #1, to a fourth feature Feature #4, which is a parameter of the (3-1)th neural network model Model #3-1, and map ninth weights and biases Weights&Biases #9, which are parameters of the first neural network model Model #1, to eighth weights and biases Weights&Biases #8 which are parameters of the (3-1)th neural network model Model #3-1. The computing device 220 may generate a second transformation table Transformation Table #2 by using the interpreter neural network model, based on above-described mapping between a parameter of a neural network model (for example, the first neural network model Model #1) for natural language processing of the user and a parameter of a partial neural network model (for example, the (3-1)th neural network model Model #3-1) corresponding thereto.

Therefore, the computational storage system 200 according to one or more embodiments may transform data, transmitted and received between an integration neural network model (e.g., trained based on a target field related DB) and a partial neural network model (e.g., trained based on an updated partial DB of the target field related DB), into a parameter which is common data between the integration neural network model and the partial neural network model and may transmit or receive the parameter, based on the training table and the transformation table of FIGS. 9 and 10, and thus, may smoothly perform data transmission/reception (or communication) between the integration neural network model and the partial neural network model.

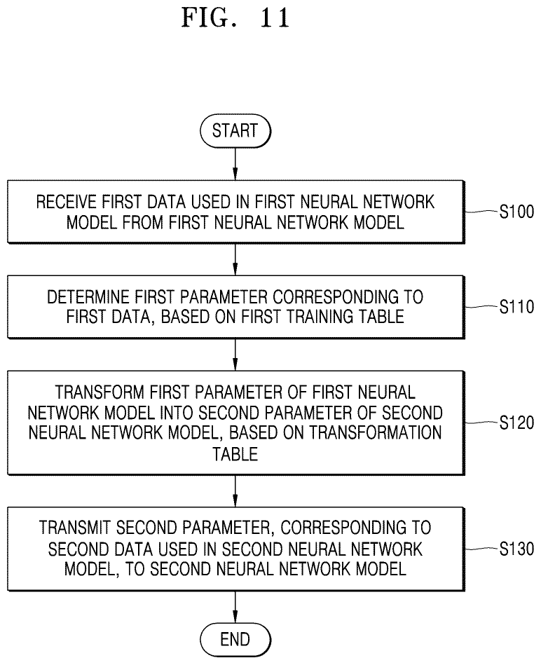

FIG. 11 is a flowchart illustrating an operating method of a computational storage system, according to one or more embodiments.

Referring to FIG. 11, a method of transforming data, transmitted and received between a plurality of neural network models, into a parameter by using an interpreter neural network model of the computational storage system 200 may include operations S100 to S120. In describing FIG. 11, descriptions which are the same as or similar to the descriptions of FIGS. 1 to 10 may be replaced with the descriptions of FIGS. 1 to 10.

In an embodiment, before performing operations S100 to S120, the computational storage system 200 may generate a training table for each of a plurality of neural network models included in the computational storage system 200. For example, the computational storage system 200 may map first data, used in a first neural network model (e.g., trained based on first training data), to a first parameter corresponding to the first data to generate a first training table, map second data, used in a second neural network model (e.g., trained based on second training data that are different from the first training data), to a second parameter corresponding to the second data to generate a second training table, and map third data, used in a third neural network model, to a third parameter corresponding to the third data to generate a third training table (see e.g., FIGS. 4 and 9).

In an embodiment, before performing operations S100 to S120, the computational storage system 200 may generate a transformation table between the plurality of neural network models included in the computational storage system 200. For example, the computational storage system 200 may map the first parameter of the first neural network model to the second parameter of the second neural network model to generate a first transformation table and may map the first parameter of the first neural network model to the third parameter of the third neural network model to generate a second transformation table (see e.g., FIGS. 5 and 10).

In operation S100, the computational storage system 200 may receive first data used in a first neural network model from the first neural network model.

In operation S110, the computational storage system 200 may determine a first parameter corresponding to the first data, based on a first training table.

In operation S120, the computational storage system 200 may transform the first parameter of the first neural network model into a second parameter of a second neural network model, based on a transformation table. In an embodiment, the computational storage system 200 may select a neural network model corresponding to the first data from among a plurality of neural network models, based on the received first data. Here, the neural network model corresponding to the first data may be assumed to be a second neural network model. The computational storage system 200 may transform the first parameter of the first neural network model into the second parameter of the second neural network model, based on a transformation table (for example, a first transformation table) between the first neural network model and the selected neural network model (for example, the second neural network model).

In operation S130, the computational storage system 200 may transmit the second parameter, corresponding to second data used in the second neural network model, to the second neural network model.

In an embodiment, the first neural network model may be a neural network model which performs a natural language processing function of a user, based on a user related DB, and the second neural network model may be a neural network model which performs a data inference function except the natural language processing function of the user, based on a predetermined target field related DB.

In an embodiment, the first neural network model may be a neural network model which is trained based on first training data in at least one eFPGA circuit of the computing device 220, and the second neural network model may be a neural network model which is trained based on second training data differing from the first training data in at least one FPGA circuit of the computing device 220.

In an embodiment, in a case where a partial DB of the target field related DB of the second neural network model is updated, the computational storage system 200 may further include a third neural network model. Here, the third neural network model may be a neural network model which performs a data inference function, based on the updated partial DB. By using the interpreter neural network model, the computational storage system 200 may map third data, used in the third neural network model, to a third parameter corresponding to the third data to generate a third training table and may map the first parameter of the first neural network model to the third parameter of the third neural network model to generate a second transformation table. By using the interpreter neural network model, the computational storage system 200 may receive fourth data used in the first neural network model from the first neural network model, select one neural network model from among the second neural network model and the third neural network model (where a neural network model corresponding to the fourth data may be assumed to be the third neural network model), based on the fourth data, determine the fourth parameter corresponding to the fourth data, based on the first training table, transform the fourth parameter of the first neural network model into a parameter of the selected neural network model (for example, the third neural network model), based on a transformation table (for example, the second transformation table) between the first neural network model and the selected neural network model (for example, the third neural network model), and transmit the parameter corresponding to fifth data to the selected neural network model (for example, the third neural network model). In this case, the first transformation table may correspond to the second neural network model, and the second transformation table may correspond to the third neural network model. Also, the fifth data may be data corresponding to the fourth data of the first neural network model among pieces of data used in the selected neural network model (for example, the third neural network model).

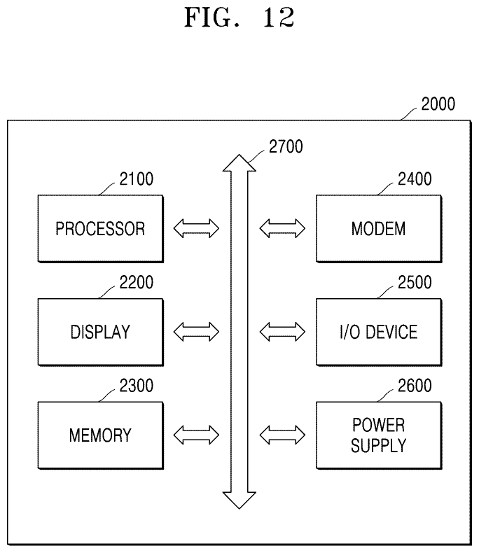

FIG. 12 is a block diagram illustrating an electronic device 2000 according to one or more embodiments.

Referring to FIG. 12, the electronic device 2000 may include a processor 2100, a display 2200, a memory 2300, a modem 2400, an input/output (I/O) device 2500, and a power supply 2600.

The processor 2100 may be a device which controls an overall operation of the electronic device 2000. The processor 2100 may drive an application and may thus perform data processing on input data. The application may include a plurality of data operations (for example, an arithmetic operation, a convolution operation, and a pooling operation) associated with task performance. For example, in a case where the processor 2100 performs a neural network-based task (for example, transforms data, transmitted and received between a plurality of neural network models, into a parameter and transmits and/or receives the parameter), the processor 2100 may include a plurality of data operations based on at least one of various kinds of neural networks included in the application and inputs, output sizes and weights, and biases of the plurality of data operations.

The processor 2100 may be implemented with a GPU, a DSP, an FPGA, an ASIC, or an NPU. However, an embodiment is not limited thereto, and the processor 2100 may be implemented with various kinds of circuits which perform in parallel data processing (for example, a data operation) needed for allocated task performance.

In an embodiment, the processor 2100 may map data, used in each of a plurality of neural network models stored in the electronic device 2000, to a parameter corresponding to the data by using an interpreter neural network model to generate a training table corresponding to each neural network model.

In an embodiment, the processor 2100 may map a parameter of a neural network model, stored in the electronic device 2000, to a parameter of another neural network model corresponding thereto by using the interpreter neural network model to generate a transformation table.

In an embodiment, the compute engine 222 may transform data, transmitted and received between the plurality of neural network models, into a parameter corresponding to the data by using the interpreter neural network model, based on the training table and the transformation table, and may transmit or receive the parameter (the plurality of neural network models may be assumed to use different data (or data representation)).

The display 2200 may output a data processing result of the processor 2100 to a user through a display panel thereof.

The memory 2300 may include a volatile memory, such as an SRAM, a DRAM, or a synchronous DRAM (SDRAM), and/or a non-volatile memory such as a PRAM, an MRAM, an ReRAM, or an FRAM.

The memory 2300 according to one or more embodiments may include a plurality of storage devices, and each of the plurality of storage devices may be implemented like the computational storage system 200 described above with reference to FIGS. 1 to 10. Moreover, the memory 2300 and the processor 2100, the display 2200, the modem 2400, the I/O device 2500, and the power supply 2600 may be connected with each other through a channel 2700, and the channel 2700 may be used in data exchange between the memory 2300 and the processor 2100, the display 2200, the modem 2400, the I/O device 2500, and the power supply 2600.

The modem 2400 may support at least one of various wireless/wired communication protocols for communicating with an external system or an external device of the electronic device 2000. The I/O device 2500 may replay communication between the user and the electronic device 2000 through a user interface including various I/O interfaces. The power supply 2600 may perform the power supply and power-related overall management of the electronic device 2000.

As the electronic device 2000 according to one or more embodiments described above is used, by using an interpreter neural network model, the processor 2100 may transform data, transmitted and received between a plurality of neural network models using different data, to a parameter which is common data between the plurality of neural network models, based on a training table and a transformation table, and thus, may smoothly perform data transmission/reception (or communication) between the plurality of neural network models.

Furthermore, as data transmission/reception (or communication) between a plurality of neural network models in the electronic device 2000 is smoothly performed, a reduction in performance caused by the delay of data transmission/reception (or communication) between the plurality of neural network models may be prevented.

Hereinabove, example embodiments have been described in the drawings and the specification. Example embodiments have been described by using the terms described herein, but this has been merely used for describing the disclosure and has not been used for limiting a meaning or limiting the scope of the disclosure defined in the following claims. Therefore, it may be understood by those of ordinary skill in the art that various modifications and other equivalent embodiments may be implemented from the disclosure. Accordingly, the spirit and scope of the disclosure may be defined based on the spirit and scope of the following claims and their equivalents.

While the disclosure has been particularly shown and described with reference to example embodiments thereof, it will be understood that various changes in form and details may be made therein without departing from the spirit and scope of the following claims and their equivalents.

What is claimed is:

1. A computational storage system comprising:
a storage device configured to store a first neural network model, a second neural network model, and an interpreter neural network model; and
a computing device configured to transform data, transmitted and received between the first neural network model and the second neural network model, into a parameter corresponding to the data by using the interpreter neural network model, based on a first training table, a second training table, and a first transformation table, and transmit and/or receive the parameter between the first neural network model and the second neural network model.

2. The computational storage system of claim 1, wherein the computing device is further configured to, by using the interpreter neural network model:
map first data used in the first neural network model to a first parameter corresponding to the first data, to generate the first training table; and
map second data used in the second neural network model to a second parameter corresponding to the second data, to generate the second training table.

3. The computational storage system of claim 2, wherein the computing device is further configured to, by using the interpreter neural network model, map the first parameter of the first neural network model to the second parameter of the second neural network model, to generate the first transformation table.

4. The computational storage system of claim 3, wherein the computing device is further configured to, by using the interpreter neural network model:
receive first data used in the first neural network model from the first neural network model;
determine the first parameter corresponding to the first data, based on the first training table;
transform the first parameter of the first neural network model into the second parameter of the second neural network model, based on the first transformation table; and
transmit the second parameter corresponding to the second data to the second neural network model, and
wherein the second data corresponds to the first data of the first neural network model, among pieces of data used in the second neural network model.

5. The computational storage system of claim 3, wherein the computing device is further configured to, by using the interpreter neural network model:
receive the second data used in the second neural network model from the second neural network model;
determine the second parameter corresponding to the second data, based on the second training table;
transform the second parameter of the second neural network model into the first parameter of the first neural network model, based on the first transformation table; and
transmit the first parameter corresponding to the first data to the first neural network model, and
wherein the first data corresponds to the second data of the second neural network model, among pieces of data used in the first neural network model.

6. The computational storage system of claim 1, wherein the first neural network model includes a neural network model configured to perform a function of natural language processing with respect to a user, based on a user-related database, and
wherein the second neural network model includes a neural network model configured to perform a data inference function, excluding the function of natural language processing with respect to the user, based on a target field-related database.

7. The computational storage system of claim 1, wherein the first neural network model includes a neural network model trained based on first training data in at least one embedded field programmable gate array (eFPGA) of the computing device, and
wherein the second neural network model includes a neural network model trained based on second training data different from the first training data in at least one field programmable gate array (FPGA) of the computing device.

8. The computational storage system of claim 6, wherein the storage device further comprises a third neural network model,
wherein the third neural network model includes a neural network model configured to, based on a partial database of a database of the second neural network model being updated, perform the data inference function, based on the updated partial database, and
wherein the computing device is further configured to, by using the interpreter neural network model, map third data, used in the third neural network model, to a third parameter corresponding to the third data, to generate a third training table; and map a first parameter of the first neural network model to the third parameter of the third neural network model, to generate a second transformation table.

9. The computational storage system of claim 8, wherein the computing device is further configured to, by using the interpreter neural network model:
receive fourth data used in the first neural network model from the first neural network model;
select a neural network model from among the second neural network model and the third neural network model, based on the fourth data;
determine a fourth parameter corresponding to the fourth data, based on the first training table;
transform the fourth parameter of the first neural network model into a parameter of the selected neural network model, based on a transformation table between the first neural network model and the selected neural network model; and
transmit the parameter corresponding to fifth data to the selected neural network model,
wherein the first transformation table corresponds to the second neural network model,
wherein the second transformation table corresponds to the third neural network model, and
wherein the fifth data corresponds to the fourth data of the first neural network model, among pieces of data used in the selected neural network model.

10. A method of operating a computational storage system based on an interpreter neural network model, the method comprising:
receiving first data used in a first neural network model from the first neural network model;
determining a first parameter corresponding to the first data, based on a first training table;
transforming the first parameter of the first neural network model into a second parameter of a second neural network model, based on a first transformation table; and
transmitting the second parameter corresponding to the second data to the second neural network model,
wherein the second data corresponds to the first data of the first neural network model, among pieces of data used in the second neural network model.

11. The method of claim 10, further comprising:
mapping the first data, used in the first neural network model, to the first parameter corresponding to the first data, to generate the first training table; and
mapping second data, used in the second neural network model, to the second parameter corresponding to the second data, to generate a second training table.

12. The method of claim 11, further comprising mapping the first parameter of the first neural network model to the second parameter of the second neural network model, to generate the first transformation table.

13. The method of claim 10, wherein the computational storage system comprises the first neural network model and the second neural network model,
wherein the first neural network model includes a neural network model configured to perform a function of natural language processing with respect to a user, based on a user-related database, and
wherein the second neural network model includes a neural network model configured to perform a data inference function, excluding the function of natural language processing with respect to the user, based on a target field-related database.

14. The method of claim 10, wherein the first neural network model includes a neural network model trained based on first training data in at least one embedded field programmable gate array (eFPGA) of a computing device included in the computational storage system, and
wherein the second neural network model includes a neural network model trained based on second training data different from the first training data in at least one field programmable gate array (FPGA) of the computing device.

15. The method of claim 13, wherein the computational storage system further comprises a third neural network model,
wherein the third neural network model includes a neural network model configured to, based on a partial database of a database of the second neural network model being updated, perform the data inference function, based on the updated partial database, and
wherein the method further comprises:
mapping third data, used in the third neural network model, to a third parameter corresponding to the third data, to generate a third training table; and
mapping the first parameter of the first neural network model to the third parameter of the third neural network model, to generate a second transformation table.

16. The method of claim 15, further comprising:
receiving fourth data used in the first neural network model from the first neural network model;
selecting a neural network model from among the second neural network model and the third neural network model, based on the fourth data;
determining a fourth parameter corresponding to the fourth data, based on the first training table;
transforming the fourth parameter of the first neural network model into a parameter of the selected neural network model, based on a transformation table between the first neural network model and the selected neural network model; and
transmitting the parameter corresponding to fifth data to the selected neural network model,
wherein the first transformation table corresponds to the second neural network model,
wherein the second transformation table corresponds to the third neural network model, and
wherein the fifth data corresponds to the fourth data of the first neural network model, among pieces of data used in the selected neural network model.

17. An electronic device comprising:
at least one memory configured store a first neural network model, a second neural network model, and an interpreter neural network model; and
at least one processor,
wherein the at least one processor is configured to, by using the interpreter neural network model:
map first data used in the first neural network model to a first parameter corresponding to the first data, to generate a first training table;
map second data used in the second neural network model to a second parameter corresponding to the second data, to generate a second training table;
map the first parameter of the first neural network model to the second parameter of the second neural network model, to generate a first transformation table; and
transform data, transmitted and received between the first neural network model and the second neural network model, into a parameter corresponding to the data, based on the first training table, the second training table, and the first transformation table, and transmit and/or receive the parameter, between the first neural network model and the second neural network model.

18. The electronic device of claim 17, wherein, in transforming the data, the at least one processor is further configured to, by using the interpreter neural network model:
receive the first data used in the first neural network model from the first neural network model;
determine the first parameter corresponding to the first data, based on the first training table;
transform the first parameter of the first neural network model into the second parameter of the second neural network model, based on the first transformation table; and
transmit the second parameter corresponding to the second data to the second neural network model, and
wherein the second data corresponds to the first data of the first neural network model. among pieces of data used in the second neural network model.

19. The electronic device of claim 17, wherein the first neural network model includes a neural network model configured to perform a function of natural language processing with respect to a user, based on a user-related database, and
wherein the second neural network model includes a neural network model configured to perform a data inference function, excluding the function of natural language processing with respect to the user, based on a target field-related database.

20. The electronic device of claim 19, wherein the at least one memory is further configured to store a third neural network model,
wherein the third neural network model includes a neural network model configured to, based on a partial database of a database of the second neural network model being updated, perform the data inference function, based on the updated partial database, and
wherein the at least one processor is further configured to, by using the interpreter neural network model:
map third data used in the third neural network model to a third parameter corresponding to the third data, to generate a third training table;
map the first parameter of the first neural network model to the third parameter of the third neural network model, to generate a second transformation table;
receive fourth data used in the first neural network model from the first neural network model;
select a neural network model from among the second neural network model and the third neural network model, based on the fourth data,
determine a fourth parameter corresponding to the fourth data, based on the first training table;
transform the fourth parameter of the first neural network model into a parameter of the selected neural network model, based on a transformation table between the first neural network model and the selected neural network model; and
transmit the parameter corresponding to fifth data to the selected neural network model, and
wherein the fifth data corresponds to the fourth data of the first neural network model, among pieces of data used in the selected neural network model.
